(19) United States
(12) Patent Application Publication
(10) Pub. No.: US 2026/0239138 A1
(43) Pub. Date: Aug. 13, 2026

(54) BASIC SERVICE SET (BSS) TRANSITION MANAGEMENT (BTM) REQUEST REASON CODES AND AUGUMENTED RESPONSE MECHANISM

(71) Applicant: Cisco Technology, Inc., San Jose, CA (US)

(72) Inventors: Robert E. Barton, Richmond (CA); Binita Gupta, San Diego, CA (US); Jerome Henry, Pittsboro, NC (US); Juan Carlos Zuniga, Montreal (CA)

(73) Assignee: Cisco Technology, Inc., San Jose, CA (US)

(21) Appl. No.: 19/281,343

(22) Filed: Jul. 25, 2025

Related U.S. Application Data
(60) Provisional application No. 63/756,671, filed on Feb. 10, 2025.

(51) Int. Cl. H04W 36/08

(52) U.S. Cl. CPC H04W 36/08

(57) ABSTRACT

A Basic Service Set (BSS) Transition Management (BTM) request reason codes and augmented response mechanism may be provided. A BTM request recommending a BSS transition for a station may be created. The BTM request may include at least one suggested Access Point (AP) for the BSS transition and a reason code for recommending the BSS transition. Then the BTM request may be sent to a station.

### RELATED APPLICATION TECHNICAL FIELD

Under provisions of 35 U.S.C. § 119(e), Applicant claims the benefit of U.S. Provisional Application No. 63/756,671 filed Feb. 10, 2025, which is incorporated herein by reference.

### TECHNICAL FIELD

The present disclosure relates generally to Basic Service Set (BSS) Transition Management (BTM) request reason codes and augmented response mechanism.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Basic Service Set (BSS) Transition Management (BTM) request reason codes and augmented response mechanism;

FIG. 2 is a flow chart of a method for providing Basic Service Set (BSS) Transition Management (BTM) request reason codes and augmented response mechanism;

FIG. 3A illustrates a Transition and Transition query reasons field;

FIG. 3B illustrates a BTM status code field; and

FIG. 4 is a block diagram of a computing device.

### DETAILED DESCRIPTION

### Overview

Basic Service Set (BSS) Transition Management (BTM) request reason codes and augmented response mechanism may be provided. A BTM request recommending a BSS transition for a station may be created. The BTM request may include at least one suggested Access Point (AP) for the BSS transition and a reason code for recommending the BSS transition. Then the BTM request may be sent to a station.

Both the foregoing overview and the following example embodiments are examples and explanatory only and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Electrical and Electronics Engineers (IEEE) 802.11v is an amendment to the IEEE 802.11 that introduces wireless network management features to improve client mobility, power efficiency, and network performance. IEEE 802.11v, for example, allows an Access Point (AP) to suggest a better AP for a station to roam to. The IEEE 802.11v may assist a station with roaming through the use of the Basic Service Set (BSS) Transition Management (BTM) mechanism. The BTM may allow the AP to suggest a roaming candidate to the station through a BTM Request message. The BTM Request message may either be solicited through a query from the station or sent unsolicited from the AP. The BTM Request message may be meant to suggest one or more roaming candidate APs/AP MLDs. In some cases, this may be to assist with moving poorly-connected stations to a better AP (e.g., as in the case of a sticky station that is mobile and needs to roam, but has not roamed yet), or it may be useful for load balancing stations across the AP infrastructure.

In either case, the AP may use the BTM Request message to influence the stations'actions, but it is up to the station to decide whether it will roam or not. That is, the BTM Request message is not enforceable; rather, the station uses the BTM Request message as a recommendation from the AP, not an imperative. How the station accepts or rejects the recommendation in the BTM Request message is up to the stations, but the station may not have to necessarily comply. However, it may provide the station with new information that can help the station roam. When an AP determines that a station should transition to a different AP, the AP may send the BTM Request message suggesting the station should roam to one of APs recommended in the BTM Request message. The AP may send the BTM Request message due to various reasons such as: signal quality degradation, load balancing needs, network management decisions, better resource allocation, better Quality of Service (QoS), etc.

The 11v BTM mechanism may have many benefits, including improved roaming dynamics, load balancing of clients, client steering, and reducing interference. However, one limitation of the current BTM mechanism is that it may not provide any information to the station on why the station is being asked to roam, even when the BTM request is being provided in response to the BTM query. The station may indicate a reason for the BTM query, but the AP suggestion for a particular candidate AP may be based on one or more criteria different from the one indicated in the BTM query, and the AP may not have a mechanism to indicate these criteria. In some cases, the station may have a specific objective function, for example, performance optimization for a certain type of application. For example, if the station has a Low Latency, Low Loss, and Scalable (L4S) traffic, an AP's ability to support the L4S traffic at a scale may be a reason the station to roam to another AP. The station may also have a low latency traffic in general and knowledge that another neighboring AP can provide better Quality of service (QoS) than the current AP may be helpful for the STA to select the another AP to roam to.

In conventional systems, after the AP sends a BTM Request, the station may reply with a BTM Response that may include a status code information if the station accepted the request (for example, setting a bit value 0) or why the station rejected the request (for example, suggested AP not found, leaving the ESS etc.). Along with the BTM Response, the station may also inform the AP of the reason the station decided not to roam to. While the BTM Response allows the station to inform the AP why it made its roaming decision (or decided not to roam), there is no provision in the BTM Request for the AP to explain why the AP may want a station to roam. Embodiments of the disclosure may provide an enhancement to the BTM Request frame where the AP includes a “reason code”, informing the station why the AP is suggesting the roam. The station then may assess if the reason is valid for its'current objective function (for example, a certain application's performance requirements), and either accept or reject the BTM request.

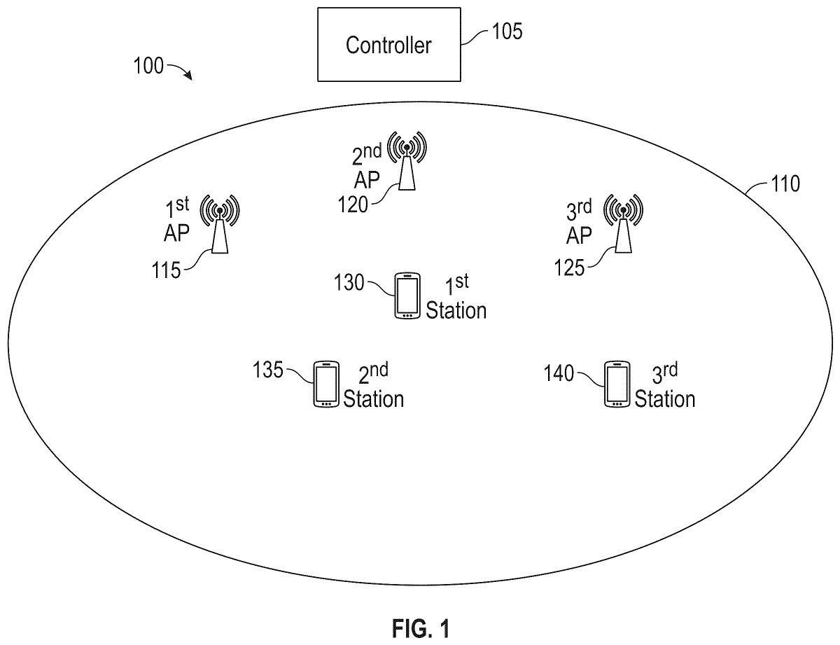

FIG. 1 shows an operating environment 100 for providing BTM request reason codes and augmented response. As shown in FIG. 1, operating environment 100 may comprise a controller 105 and a coverage environment 110. Coverage environment 110 may comprise, but is not limited to, a Wireless Local Area Network (WLAN) comprising a plurality of APs that may provide wireless network access (e.g., access to the WLAN for client devices (also referred to as stations)). The plurality of APs may comprise a first AP 115, a second AP 120, a third AP 125. The plurality of APs may provide wireless network access to a plurality of stations as they move within coverage environment 110. The plurality of stations may comprise, but are not limited to, a station 130, a second station 135, and a third station 140. Ones of the plurality of stations may comprise, but are not limited to, a smart phone, a personal computer, a tablet device, a mobile device, a telephone, a remote control device, a set-top box, a digital video recorder, an Internet-of-Things (IoT) device, a network computer, a router, Virtual Reality (VR)/Augmented Reality (AR) devices, or other similar microcomputer-based device. Each of the plurality of APs may be compatible with specification standards such as, but not limited to, the Institute of Electrical and Electronics Engineers (IEEE) 802.11 specification standard for example.

The plurality of APs and the plurality of stations may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of stations may be made with any one AP or with any combination of the APs.

Controller 105 may comprise a Wireless Local Area Network controller (WLC) and may provision and control coverage environment 110 (e.g., a WLAN). Controller 105 may allow first station 130, second station 135, and third station 140 to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide a multi-link procedure to identify link disablement in Basic Service Set (BSS) transition management frames.

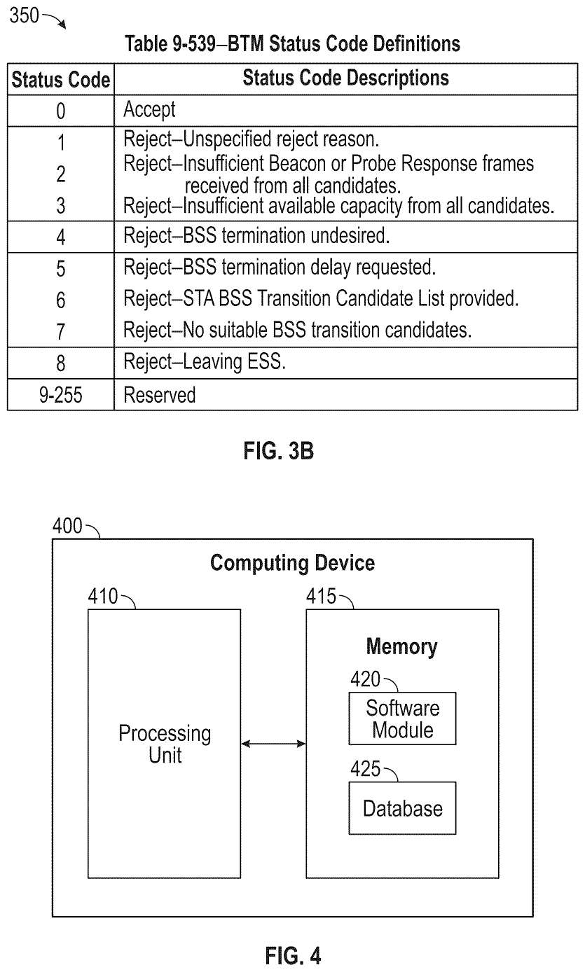

The elements described above of operating environment 100 (e.g., controller 105, first AP 115, second AP 120, third AP 125, first station 130, second station 135, or third station 140) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

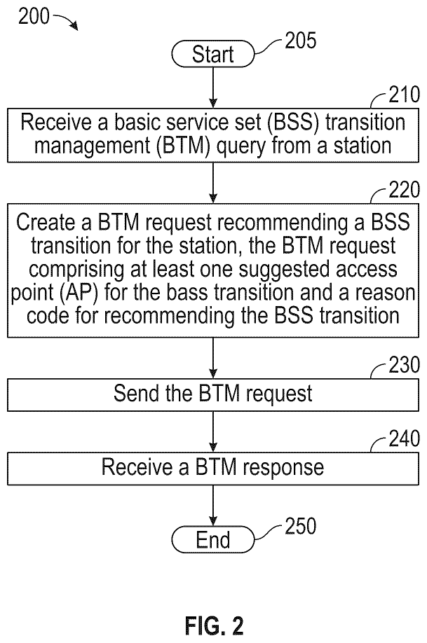

FIG. 2 is a flow chart setting forth the general stages involved in a method 200 consistent with embodiments of the disclosure providing BTM request reason codes and augmented response mechanism. Method 200 may be implemented using computing device 400 as described in more detail below with respect to FIG. 4. Computing device 400 may be embodied by first AP 115. Ways to implement the stages of method 200 will be described in greater detail below.

Method 200 may begin at starting block 205 and proceed to stage 210 where first AP 115 may receive a BTM query from first station 130. First station 130 may send first AP 115 a BTM query that may solicit a BTM request. For example, if a Received Signal Strength Indicator (RSSI) of the currently associated AP is too low or first station 130 discovered a better AP, first station 130 may send a BTM query to the associated AP (e.g., first AP 115). Upon receiving the query, the AP may respond with a BTM request as described below. In other embodiments, the BTM request may be unsolicited. For example, if first AP 115 detects that the RSSI of first station 130 is lower than the RSSI threshold, it may send the BTM request to first station 130 unsolicited.

From stage 210, where first AP 115 receives the BTM query, method 200 may advance to stage 220 where first AP 115 may create a BTM request for first station 130. The BTM request may include at least one suggested AP for the BSS transition and a reason code for recommending the BSS transition.

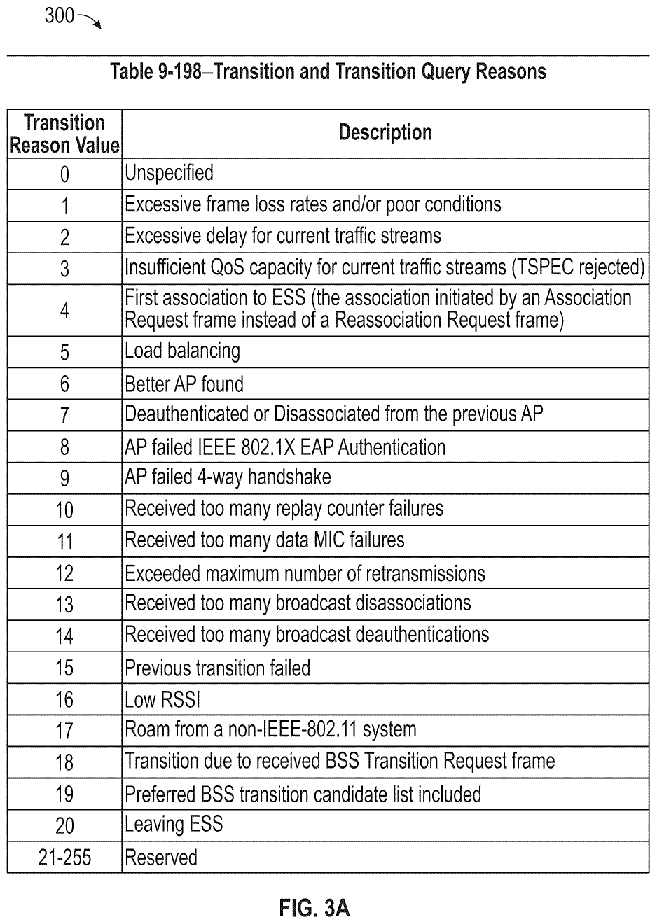

The reason code may include any number of reasons given to first station 130 that may include application-centric or QoS-centric reasons. Example reason codes that may be provided in the BTM Request frame may include one or more of the reason codes from the ‘Transition and Transition Query reasons’ field 300 provided in FIG. 3A. In addition, the BTM request frame may include other reason codes, indicative of following (but not limited to only these): a better QoS AP, L4S performance degrading on first AP 115; better L4S performing AP, AP with a premium link, etc. In some examples, there can be multiple reason codes given in the BTM Request frame by first AP 115. For example, the BTM Request frame may indicate both ‘Load balancing’and “Better L4S performing AP suggested’.

In one embodiment, one or more reason codes may be included that apply for the entire BTM request indicating the reasons why the BSS transition is recommended by first AP 115. One example way this can be achieved is by adding a list of one or more (extended) ‘Transition and Transition Query reasons’ field the BTM Request frame. The presence of this new field may be indicated by using one of the Reserved bits in a Request Mode field.

In another embodiment, the BTM Request may provide one or more reason codes specific to each recommended BSS Transition candidate AP (that is, one or more suggested APs). This way first AP 115 may recommend specific reasons for each of the BSS transition candidate AP, for example, the candidate AP may indicate ‘Better performing L4S AP’ for one BSS transition candidate AP and can indicate ‘premium link AP’ for another BSS transition candidate AP. One example way this may be achieved is by including a list of one or more (extended) ‘Transition and Transition Query reasons’ field as a sub-element for each BSS transition candidate.

Once first AP 115 creates the BTM request in stage 220, method 200 may continue to stage 230 where first AP 115 may send the BTM request. For example, first station 130 may receive the BTM request sent by first AP 115. As stated above the request may be solicited or unsolicited.

After first AP 115 sends the BTM request in stage 230, method 200 may proceed to stage 240 where first AP 115 may receive a BTM response. For example, upon receiving the BTM request, first station 130 may determine whether to disconnect from first AP 115 and roam to a recommended AP. If first station 130 determines to perform a roaming, it may send the BTM response to first AP 115. Once first AP 115 receives the BTM response in stage 240, method 200 may then end at stage 250.

An example advantage of providing one or more reason codes in the BTM Request is that it may allow first station 130 to implement an application-centric, or QoS-centric objective function to perform the roam. That is, it may allow first station 130 to decide if provided reasons are important enough to initiate a roam and if, when discovering a candidate AP, the candidate AP provides a level of service better enough to justify the roam. For example, if first AP 115 sends a BTM Request to first station 130 with a reason code field informing first station 130 that the L4S is declining across the BSS (queue is building), then first station 130 may determine whether this is important enough to initiate a roam. For example, if first station 130 is transmitting or receiving a large amount of L4S traffic, this may be enough to trigger a roam action. However, if the L4S traffic is unimportant to first station 130 (for example, it may not even support L4S), then first station 130 may ignore the BTM Request, and then may reply back an augmented BTM Response, informing first AP 115 that the reason code is not relevant. In one example, this may be achieved by adding a new value indicating ‘Reject—BTM Request reason codes not relevant’ for the BTM status code field 350 shown in FIG. 3B in the BTM Response frame.

The BTM Request may also indicate a BSS transition candidate AP that can provide better L4S performance through the reason code, then first station 130 may use that information to select roaming to that candidate AP. When deciding to roam and receiving the candidate AP's BSS Load Information Element (IE), first station 130 may also decide that the next AP present performance conditions is not as desired and that can lead first station 130 to prefer to stay on the current AP (that is, first AP 115), despite the L4S degrading conditions.

As discussed above, another embodiment may include first STA's 130 ability to interpret the reason code and initiate a roaming action based on its own objective function. The objective function may be one or more criteria by which first station 130 may decide to roam. Traditionally, roaming decisions may primarily be done for Radio Frequency (RF) reasons, however, expanding this to an application-centric, or QoS-centric perspective, the roaming criteria may be dependent on certain application requirements. Thus, first station 130 may consider which objective function is most important (i.e., which applications need to have the best experience), and then decide its action based on the reason codes in the BTM Request accordingly.

In augmentation to the conventional BTM status code in the BTM Response (as shown in FIG. 3B), in example embodiments, first station 130 may inform first AP 115 of the roaming decision in the context of first AP's115 BTM Request. That is, first station 130 may inform first AP 115 why it may choose to roam or not based on how important the reason code in the BTM Request was, but also based on the comparison of conditions (given first station's 130 objective functions) between the first AP 115 and the candidate AP. The disclosure may enhance the BTM status code in the BTM Response frame to add more specific accept status codes indicating more granular reasons why first station 130 accepted the BTM Request.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing BTM) request reason codes and augmented response mechanism as described above with respect to FIG. 2. Computing device 400, for example, may provide an operating environment for controller 105, first AP 115, second AP 120, third AP 125, first station 130, second station 135, or third station 140. Controller 105, first AP 115, second AP 120, third AP 125, first station 130, second station 135, or third station 140 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
creating a Basic Service Set (BSS) Transition Management (BTM) request recommending a BSS transition for a station, wherein the BTM request comprising at least one suggested Access Point (AP) for the BSS transition and a reason code for recommending the BSS transition; and
sending the BTM request to the station.

2. The method of claim 1, wherein the reason code is provided for an entire BTM request received from the station.

3. The method of claim 1, wherein the reason code is provided in one or more extended transition and transition query reasons field in a BTM Request frame.

4. The method of claim 1, wherein a presence of the one or more extended transition and transition query reasons field is indicated in one of a reserved bits in a request mode field of the BTM Request frame.

5. The method of claim 1, wherein the BTM request further comprises one or more reason codes specific to each of the at least one suggested AP.

6. The method of claim 5, wherein the one or more reason codes specific to each of the at least one suggested AP is provided in a one or more transition and transition query reasons field as a sub-element for each of the at least one suggested AP.

7. The method of claim 1, wherein the reason code comprises a better Low Latency, Low Loss, and Scalable (L4S) candidate.

8. The method of claim 1, further comprising:
receiving a BTM query; and
creating the BTM request in response to receiving the BTM query.

9. The method of claim 1, wherein the BTM request comprises an unsolicited request.

10. The method of claim 1, further comprising receiving a BTM response.

11. A system comprising:
a memory storage; and
a processing unit coupled to the memory storage, wherein the processing unit is operative to:
create a Basic Service Set (BSS) Transition Management (BTM) request recommending a BSS transition for a station, wherein the BTM request comprising at least one suggested Access Point (AP) for the BSS transition and a reason code for recommending the BSS transition; and
send the BTM request to the station.

12. The system of claim 11, wherein the reason code is provided for an entire BTM request received from the station.

13. The system of claim 11, wherein the reason code is provided in one or more extended transition and transition query reasons field in a BTM Request frame.

14. The system of claim 13, wherein a presence of the one or more extended transition and transition query reasons field is indicated in one of a reserved bits in a request mode field of the BTM Request frame.

15. The system of claim 11, wherein the BTM request further one or more reason codes specific to each of the at least one suggested AP, and wherein the one or more reason codes specific to each of the at least one suggested AP is provided in a one or more transition and transition query reasons field as a sub-element for each of the at least one suggested AP.

16. The system of claim 11, further comprising:
receiving a BTM query; and
creating the BTM request in response to receiving the BTM query.

17. A non-transitory computer-readable medium that stores a set of instructions which when executed perform a method executed by the set of instructions comprising:
creating a Basic Service Set (BSS) Transition Management (BTM) request recommending a BSS transition for a station, wherein the BTM request comprising at least one suggested Access Point (AP) for the BSS transition and a reason code for recommending the BSS transition; and
sending the BTM request to the station.

18. The non-transitory computer-readable medium of claim 17, wherein the reason code is provided for an entire BTM request received from the station.

19. The non-transitory computer-readable medium of claim 17, wherein the reason code is provided in one or more extended transition and transition query reasons field in a BTM Request frame.

20. The non-transitory computer-readable medium of claim 17, further comprising:
receiving a BTM query; and
creating the BTM request in response to receiving the BTM query.
